(19) United States
(12) Patent Application Publication
(10) Pub. No.: US 2025/0116630 A1
(43) Pub. Date: Apr. 10, 2025

(54) FLUIDIC CARTRIDGE ASSEMBLY

(71) Applicant: Intabio, LLC, Fremont, CA (US)

(72) Inventors: Wesley CHANG, Fremont, CA (US); Brian PETERSON, Brea, CA (US); Hongfeng YIN, Fremone, CA (US)

(21) Appl. No.: 18/900,775

(22) Filed: Sep. 29, 2024

Related U.S. Application Data
(60) Provisional application No. 63/587,780, filed on Oct. 4, 2023.

(51) Int. Cl. G01N 27/447

(52) U.S. Cl. CPC G01N 27/44791; G01N 27/4473; G01N 27/44743

(57) ABSTRACT

Disclosed and described herein is a cartridge assembly with a fluidic device and harness and method of use.

### RELATED APPLICATIONS

The present patent application claims the priority benefit of U.S. Provisional Patent Application Ser. No. 63/587,780, filed Oct. 4, 2023, the content of which is hereby incorporated by reference in its entirety into this disclosure.

### BACKGROUND

Separation of analyte components from a more complex analyte mixture on the basis of an inherent quality of the analytes, and providing sets of fractions that are enriched for states of that quality, is a key part of analytical chemistry. Simplifying complex mixtures in this manner reduces the complexity of downstream analysis. However, complications can arise when attempting to interface known enrichment methods and/or devices with analytical equipment and/or techniques.

A variety of methods have been used, for example, to interface sample separation techniques with downstream detection systems such as mass spectrometers. One method includes the use of fluidic devices (e.g., chip-based microfluidic devices). Fluidic devices may be produced by various known techniques and provide fluidic channels of defined dimensions that can make up a channel network designed to perform different fluid manipulations. However, when fluidic devices are connected to the rest of an analytical system (e.g., parts of the system that contain samples and reagents), fittings and tubing that are often used for fluidic connections with the fluidic device (e.g., a chip-based microfluidic devices) can cause turbulent flow and air bubble entrapment at their interface. In addition, the interfaces for fluidic devices may require transitions between different geometries and sizes, and different sized and shaped outlets and inlets (e.g., within the analytical system and/or the fluidic device) can create a zone of dead volume or leaks in fluid communication between fluidic devices and the rest of the analytical system. The zone of dead volume or leaks can cause difficulty with analysis, especially if the analysis is sensitive to such variations (e.g., where microfluidic devices, small sample volume, and/or data correlation is done with downstream detection). There is a need for a device, cartridge assembly, system or method with a better interface for fluidic devices (e.g., to reduce the dead volume or leaks, and to improve reproducibility and resolution of the analysis using such fluidic devices).

### BRIEF SUMMARY

One aspect of the disclosure is a cartridge assembly including a fluidic device including a separation channel, at least one fluid inlet and at least one fluid outlet, and a harness including at least a first polymer component and a second polymer component; wherein the first polymer component comprises a low melting point polymer and at least one harness orifice, and the second polymer component comprises a laminate of high melting point polymer, at least one harness channel, at least one harness channel inlet, and at least one harness channel outlet; wherein the at least one harness channel outlet is configured to align with the least one harness orifice; and the least one harness orifice is configured to align with the at least one fluid inlet.

One aspect of the disclosure is a method for an electrophoretic separation, comprising introducing a sample comprising at least one analyte into the separation channel of the disclosed cartridge assembly, applying an electric field across the separation channel to separate the sample generating at least one analyte peak, and detecting the at least one analyte peak with a detector.

In an aspect, the laminate of high melting point polymer comprises at least a first high melting point polymer layer, a second high melting point polymer layer, and a third high melting point polymer layer.

In an aspect, the second high melting point polymer layer comprises the harness channel.

In an aspect, at least a portion of the harness channel is cut into the second high melting point polymer layer.

In an aspect, the first high melting point polymer layer and the third high melting point polymer layer comprise the at least one harness channel inlet and/or at least one harness channel outlet. In an aspect, the first high melting point polymer layer comprises the at least one harness channel outlet and the third high melting point polymer layer comprises the at least one harness channel inlet, and wherein the second high melting point polymer layer is positioned in between the first high melting point polymer layer and the third high melting point polymer layer.

In an aspect, the harness channel comprises a first portion and a second portion, wherein the first portion is configured to align with the harness channel inlet and the second portion is configured to align with the harness channel outlet.

In an aspect, the first polymer component is bonded to the second polymer component.

In an aspect, the harness is sealed at an interface between the harness orifice and the fluid inlet using pressure and/or heat.

In an aspect, the low melting point polymer has a melting point at least about 20° less than the melting point of the high melting point polymer, alternatively at least about 50° less, at least about 75° less, at least about 100° less, at least about 125° less, at least about 150° less, at least about 175° less, or at least about 200° less.

In an aspect, the separation channel is configured to perform electrophoretic separation. In an aspect, the separation channel comprises a separation channel inlet, wherein the at least one fluid inlet is the separation channel inlet and a separation channel outlet, wherein the at least one fluid outlet is the separation channel outlet. In an aspect, the at least one fluid outlet is in fluid communication with an electrospray ionization orifice.

In an aspect, the fluidic device further comprises at least one electrolyte channel each comprising at least one electrolyte channel inlet, wherein one of the at least one fluid inlet is the at least one electrolyte channel inlet. In an aspect, the at least one electrolyte channel is a catholyte channel, an anolyte channel, or a mobilizer channel.

In an aspect, the harness comprises at least two harness orifices, wherein each harness orifice is independently configured to align with the at least one separation channel inlet and the at least one electrolyte channel inlet.

In an aspect, the harness comprises at least four harness orifices, wherein each harness orifice is independently configured to align with the at least one separation channel inlet, the anolyte channel inlet, the catholyte channel inlet, and the mobilizer channel inlet.

In an aspect, the fluidic device further comprises at least one gas channel each comprising at least one gas channel inlet, wherein one of the at least one fluid inlet is the at least one gas channel inlet.

In an aspect, the harness comprises at least five harness orifices, wherein each harness orifice is independently configured to align with the at least one separation channel inlet, the anolyte channel inlet, the catholyte channel inlet, the mobilizer channel inlet, and the at least one gas channel inlet.

In an aspect, the at least one separation channel inlet, the at least one electrolyte channel inlet, and the at least one gas channel inlet are disposed along a first edge of the fluid device.

In an aspect, the cartridge assembly further includes a housing configured to encompass at least a portion of the fluid device, wherein the housing comprises at least one housing outlet and/or at least one housing channel.

In an aspect, the at least one harness channel inlet is configured to align with the at least one housing outlet.

In an aspect, the harness orifice does not require additional fittings, attachments, o-rings, gaskets, tubing and/or elastomeric seals to seal the harness orifice to the fluid inlet and/or the harness channel outlet.

In an aspect, the harness channel inlet does not require additional fittings, attachments, o-rings, gaskets, tubing and/or elastomeric seals to seal the harness channel inlet to the harness orifice and/or the housing outlet.

In an aspect, the cartridge assembly further includes an electrode electrically connected to the harness channel and/or the housing channel. In an aspect, the electrode is disposed at an electrode reservoir.

In an aspect, the cartridge assembly further includes a permeable ion membrane disposed between the electrode reservoir and the harness channel or the housing channel.

### BRIEF DESCRIPTION OF THE DRAWINGS

Aspects of the present disclosure will now be described, by way of example only, with reference to the attached Figures, wherein:

FIG. 1A and 1B provides views of a cartridge assembly according to an aspect of the disclosure.

FIG. 2 provides a perspective view of a fluidic device according to an aspect of the disclosure.

FIG. 3 is an illustration of the interface between the fluidic device and harness according to an aspect of the disclosure.

FIG. 4 is an illustration of harness according to an aspect of the disclosure.

FIG. 5 is a close up view of the interface between a harness and a fluidic device according to an aspect of the disclosure.

### DETAILED DESCRIPTION

Fluidic devices (e.g., chip-based microfluidic devices) are attractive tools for separation and further downstream analysis of analytes. However, interfacing fluidic devices with the rest of the analytical system might present problems such as leaks, turbulent flow, air (or other gas) bubbles entrapment, and the difficult of transitions between different geometries and sizes. Fluidic devices (e.g., those with edge port designs) often require elastomeric seals. For example, chip-based devices (e.g., chip-based microfluidic devices) might have fluidic paths with fluid(s) entering the chip from the side of the chip through holes of certain shape and size. Yet it might be desirable to interface such chip-based device with another component (e.g., a component of the rest of the analytical system) having holes of different shape and/or size. The transition from one size/shape to another size/shape might create a zone prone to leakage and having a dead volume that could trap air bubbles. Thus, there is a need for better a device, cartridge assembly, system, or method to interface fluidic devices (e.g., to reduce the dead volume or leaks). Certain disclosed cartridge assemblies and methods address the need by interfacing fluidic devices in a simple, robust, and/or adaptable to various configurations way.

Unless otherwise defined, all technical and scientific terms used herein have the same meaning as commonly understood by one of ordinary skill in the art to which the methods described herein belong. Any reference to standard methods (e.g., ASTM, TAPPI, AATCC, etc.) refers to the most recent available version of the method at the time of filing of this disclosure unless otherwise indicated.

For any method disclosed herein that includes discrete steps, the steps may be conducted in any feasible order. And, as appropriate, any combination of two or more steps may be conducted simultaneously.

All headings are for the convenience of the reader and should not be used to limit the meaning of the text that follows the heading, unless so specified.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements.

By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The singular form “a”, “an” and “the” include plural referents unless the context clearly dictates otherwise. These articles refer to one or to more than one (i.e., to at least one). As used herein, the term “or” is generally employed in its usual sense including “and/or” unless the content clearly dictates otherwise. The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

Where ranges are given, endpoints include all numbers subsumed within that range (e.g., 1 to 5 includes 1, 1.5, 2, 2.75, 3, 3.80, 4, 5, etc.). Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise. Herein, “up to” a number (for example, up to 50) includes the number (for example, 50). The term “in the range” or “within a range” (and similar statements) includes the endpoints of the stated range.

Reference throughout this specification to “one aspect,” “an aspect,” “certain aspects,” or “some aspects,” etc., means that a particular feature, configuration, composition, or characteristic described in connection with the aspect is included in at least one aspect of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more aspects.

Unless otherwise indicated, all numbers expressing quantities of components, molecular weights, and so forth used in the specification and claims are to be understood as being modified in all instances by the term “about.” As used herein in connection with a measured quantity, the term “about” refers to that variation in the measured quantity as would be expected by the skilled artisan making the measurement and exercising a level of care commensurate with the objective of the measurement and the precision of the measuring equipment used. The term “about” as used in connection with a numerical value throughout the specification and the claims denotes an interval of accuracy, familiar and acceptable to a person skilled in the art. In general, such interval of accuracy is +/−10%. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The term “exemplary” means serving as a non-limiting example, instance, or illustration. As utilized herein, the terms “e.g.,” and “for example” set off lists of one or more non-limiting aspects, examples, instances, or illustrations.

As used herein, the term “substantially” refers to the qualitative condition of exhibiting total or near-total extent or degree of a characteristic or property of interest. Biological and chemical phenomena rarely, if ever, go to completion and/or proceed to completeness or achieve or avoid an absolute result. The term “substantially” is therefore used herein to capture the potential lack of completeness inherent in many biological and chemical phenomena. For example, “substantially” may refer to being within at least about 20%, alternatively at least about 10%, alternatively at least about 5% of a characteristic or property of interest.

The invention is defined in the claims. However, below is a non-exhaustive listing of non-limiting exemplary aspects. Any one or more of the features of these aspects may be combined with any one or more features of another example, embodiment, or aspect described herein.

### Cartridge Assembly

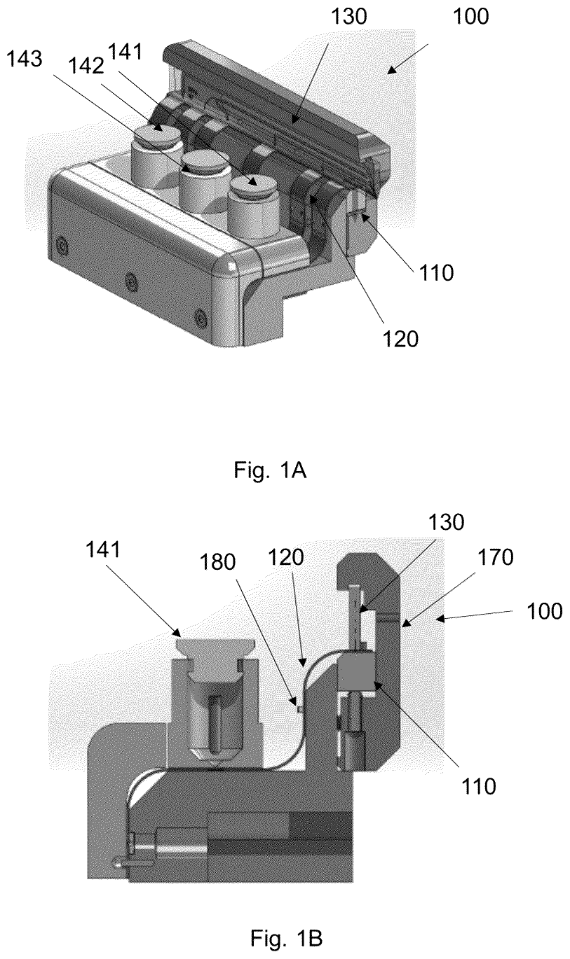

FIG. 1A provides an example perspective view of a cartridge assembly 100 including a fluidic device 130, harnesses 120, housing 110, and reservoirs 141, 142, 143. FIG. 1B provides an example sectional view of a cartridge assembly 100 including a fluidic device 130, harnesses 120, portion of a housing 110 (comprising at least one housing outlet and/or at least one housing channel, not shown), reservoir 141, and portion of a housing 170 (encompassing at least a portion of the fluid device and, in an embodiment, functioning as a clamp to facilitate sealing of the fluidic device 130 with harness 120). FIG. 1B also provides an example of an element 180 (with a corresponding hole in a harness) that can be used for aligning the harness. In one aspect, the fluidic device 130 includes a separation channel, at least one fluid inlet and at least one fluid outlet.

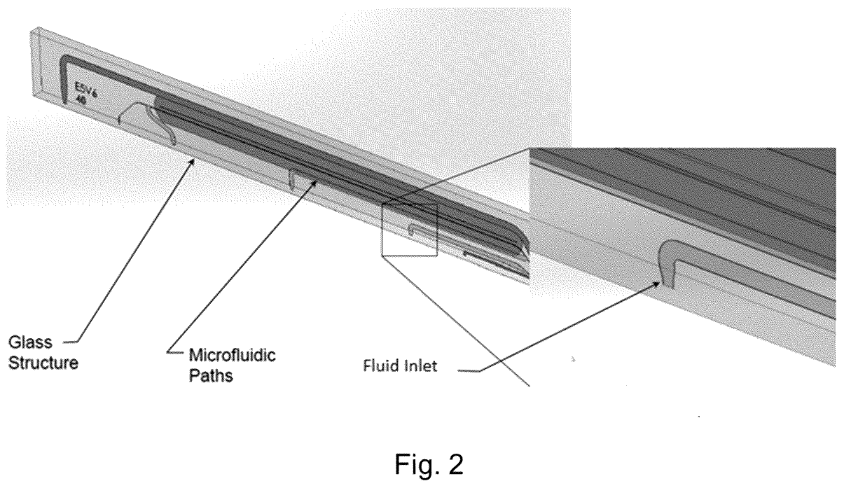

FIG. 2 provides a perspective view of a fluidic device according to an aspect of the disclosure. In this this aspect, the fluidic device is a capillary electrophoresis chip (e.g., microfluidic chip used for isoelectric focusing separation) with an edge port design. In FIG. 2, the chip is manufactured out of glass, but in other non-limiting aspects, the chip may be manufactured out of quartz, fused silica, plastic, polycarbonate, PFTE, PDMS, silicon, polyfluorinated polyethylene, polymethacrylate, cyclic olefin copolymer, cyclic olefin polymer, polyether ether ketone and/or any other suitable material. Mixtures of materials can be utilized if different properties are desired in different layers of a planar substrate and/or any other suitable material. Mixtures of materials can be utilized if different properties are desired in different layers of a planar substrate.

The fluid inlets and/or fluid outlets may be part of a fluidic path (e.g., on the microfluidic chip). In a non-limiting example the fluid inlet may any shape. For example, the fluid inlet may be round, oval, square, rectangular, substantially oval, substantially square, substantially rectangular, or a slotted hole. In an embodiment, the microfluidic paths may be an electrolyte channel each comprising at least one electrolyte channel inlet, wherein one of the at least one fluid inlet is the at least one electrolyte channel inlet. In some aspects, the electrolyte channel may be a catholyte channel, an anolyte channel, or a mobilizer channel. In some aspects, the at least one fluid outlet is in fluid communication with an electrospray ionization orifice.

In an aspect, the separation channel may be used to separate and/or enrich an analyte and/or a portion (e.g., a fraction) of a sample. In an non-limiting aspect, the separation channel may be used to perform electrophoretic separations (e.g., isoelectric focusing, capillary gel electrophoresis, capillary zone electrophoresis, isotachophoresis, capillary electrokinetic chromatography, micellar electrokinetic chromatography, flow counterbalanced capillary electrophoresis, electric field gradient focusing, dynamic field gradient focusing). The separation channel may also include a separation channel inlet, wherein the at least one fluid inlet is the separation channel inlet and a separation channel outlet, wherein the at least one fluid outlet is the separation channel outlet.

In an aspect, the fluidic device further includes at least one gas channel inlet, wherein one of the at least one fluid inlet is the at least one gas channel inlet. In an embodiment, at least one gas channel inlet, wherein one of the at least one fluid inlet is the at least one gas channel inlet.

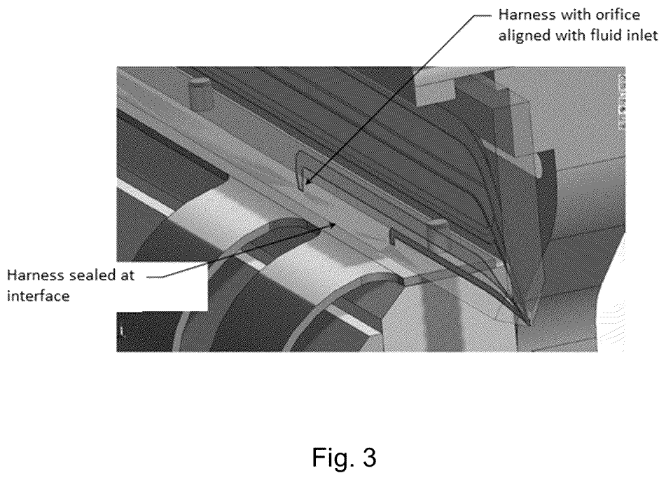

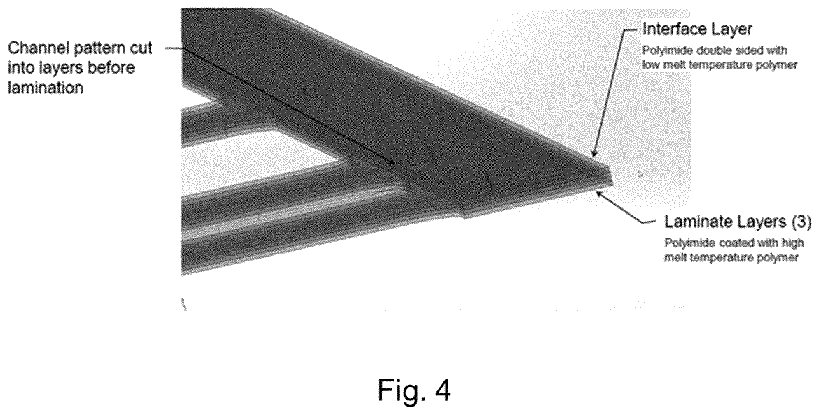

As shown in FIG. 3, the harness is configured to align with at least one fluid inlet of the fluidic device. The harness may also be heat and pressure bonded to the fluidic device. In some aspects, the harness includes a first polymer component and a second polymer component. The first polymer component may include a low melting point polymer and at least one harness orifice, while the second polymer component may include a laminate of high melting point polymer, at least one harness channel, at least one harness channel inlet, and at least one harness channel outlet. In an embodiment, the harness channel outlet is configured to align with the least one harness orifice and the harness orifice is configured to align with the at least one fluid inlet. In an aspect, the harness is sealed at an interface between the harness orifice and the fluid inlet using pressure and/or heat. FIG. 4 shows more detail of one embodiment of a harness.

Various polymers can be used depending on the bonding desired. In some aspects, the low melting point polymer has a melting point at least about 20° less than the melting point of the high melting point polymer, alternatively at least about 50° less, at least about 75° less, at least about 100° less, at least about 125° less, at least about 150° less, at least about 175° less, or at least about 200° less.

The laminate is made of multiple layers. In one aspect, the laminate of high melting point polymer includes at least a first high melting point polymer layer, a second high melting point polymer layer, and a third high melting point polymer layer. In this aspect, the second high melting point polymer layer may include the harness channel. In one aspect, at least a portion of the harness channel is cut into or otherwise formed into the second high melting point polymer layer. In some aspects, prior to the lamination process, fluidic channels and outlets are cut in the material. The cutting can be done using any method, including, but not limited two laser cutting. In an embodiment, the laser cutting process allows the ports to be sized to match the ports on the edge of the fluidic device.

In an aspect, the first high melting point polymer layer and the third high melting point polymer layer include the at least one harness channel inlet and/or at least one harness channel outlet. For example, the first high melting point polymer layer includes the at least one harness channel outlet and the third high melting point polymer layer includes the at least one harness channel inlet, and wherein the second high melting point polymer layer is positioned in between the first high melting point polymer layer and the third high melting point polymer layer. Additionally, the harness channel may include a first portion and a second portion, wherein the first portion is configured to align with the harness channel inlet and the second portion is configured to align with the harness channel outlet. In an aspect, the first polymer component is bonded to the second polymer component.

The harness may include multiple orifices depending on the analysis desired. For example, the harness may include at least two harness orifices, wherein each harness orifice is independently configured to align with the at least one separation channel inlet and the at least one electrolyte channel inlet. In another aspect, the harness includes at least four harness orifices, wherein each harness orifice is independently configured to align with the at least one separation channel inlet, the anolyte channel inlet, the catholyte channel inlet, and the mobilizer channel inlet. When a gas channel is present, the harness may include at least five harness orifices, wherein each harness orifice is independently configured to align with the at least one separation channel inlet, the anolyte channel inlet, the catholyte channel inlet, the mobilizer channel inlet, and the at least one gas channel inlet.

The housing of the cartridge assembly may be configured to encompass at least a portion of the fluid device, wherein the housing includes at least one housing outlet and/or at least one housing channel. The harness channel inlet may be configured to align with the at least one housing outlet.

The cartridge assembly may also include an electrode electrically connected to the harness channel and/or the housing channel. In some aspects, the electrode is disposed at an electrode reservoir. The cartridge assembly may also include a permeable ion membrane disposed between the electrode reservoir and the harness channel or the housing channel.

In an embodiment, the harness (e.g., shown in FIGS. 1A and 1B) comprises at least a first polymer component and a second polymer component. In an example, the second polymer component may be made by laminating a high melting polymer. In an example, such lamination might take place without the first polymer component. In an example, the first polymer component then might be added (e.g., during an assembly of the harness or cartridge assembly). In an example, the fluidic device and harness are then clamped through the clamp structure. In an example, the harness is sealed at an interface between the harness orifice and the fluid include using pressure and/or heat. In an example, the harness may be heated to flow the first polymer component to provide fluid seal. In an example, the harness with the fluidic device is then assembled on a housing with ion membranes and fluid seals in place. In an aspect, the harness may be is pressed between the fluidic device and the housing in order to form a sealed fluid channel.

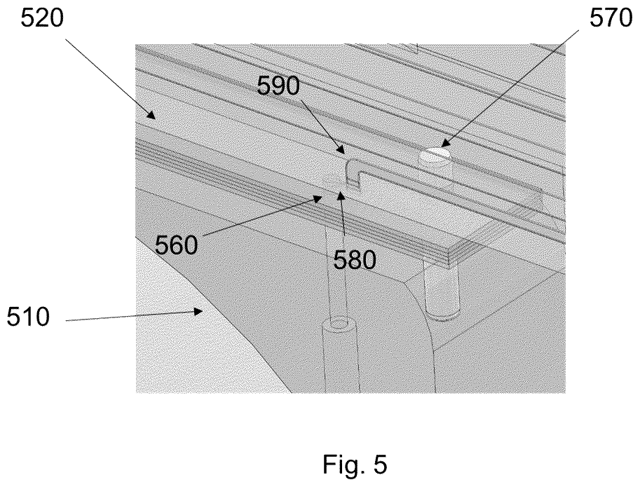

FIG. 5 provides a close-up view of the harness 520, a housing outlet 560 and a fluidic device inlet 590. In some embodiments, the geometry of the housing outlet 560 is not the same as the geometry of the fluidic device inlet 590. For example, the housing outlet 560 is round and the fluidic device inlet 590 is a slotted hole. A harness channel 580 provides fluid communication between a housing outlet 560 and fluidic device inlet 590. A pin 570 holds the harness 520 in place and secures it aligning the harness orifices with the fluidic device inlet 590 as well as the housing outlet 560. In operation, pressure and/or heat can seal the interface between the housing 510 and the harness channel 580 as well as between the harness channel 580 and the fluidic device. In alternative embodiments, different configurations are possible for outlets, harnesses, inlets, reservoirs, fluidic devices, and analytical devices.

A unique aspect of this disclosure is that the harness orifice does not require additional fittings, attachments, o-rings, gaskets, tubing, and/or elastomeric seals to seal the harness orifice to the fluid inlet and/or harness channel outlet. Another unique aspect of this disclosure is that the harness channel inlet (of a cartridge assembly) does not require additional fittings, attachments, o-rings, gaskets, tubing and/or elastomeric seals to seal the harness channel inlet to the harness orifice and/or the housing outlet. For example, as shown in FIG. 3, the harness orifice and/or the harness channel inlet is sealed at the interface without any additional fittings, attachments, o-rings, gaskets, tubing, and/or elastomeric seals. For example, a harness shown in FIG. 4. may be used in an interface like the one shown in FIG. 3. And, for example, a first polymer component (comprising a low melting point polymer) of the harness may be in a direct contact with a fluid device and the harness orifice (of the first polymer component) is sealed to the fluid inlet and/or harness channel outlet. In some embodiments, the harness is sealed at an interface between the harness orifice and the fluid inlet using pressure and/or heat. In an embodiment, as shown in FIG. 1B, a portion of a housing 170 may facilitate the sealing. For example, it may function as a clamp to facilitate sealing. In an example as shown in FIG. 5, a housing outlet 560 may not be aligned (and might be of a different shape/size) as compared to a fluidic device inlet 590, making it difficult to provide sealing. In an example, as shown in FIG. 5, a harness channel 580 provides fluid communication between a housing outlet 560 and fluidic device inlet 590 and the harness orifice is sealed to the fluid inlet and/or harness channel outlet and/or the harness channel inlet is sealed to the harness orifice and/or the housing outlet without additional fittings, attachments, o-rings, gaskets, tubing, and/or elastomeric seals. In some examples, as shown in FIG. 1B, an element 180 (with a corresponding hole in a harness) can be used for aligning the harness, but a harness orifice and/or a harness channel inlet require no additional fittings, attachments, o-rings, gaskets, tubing, and/or elastomeric seals for the sealing. In some examples, as shown in FIG. 5, a pin 570 holds the harness 520 in place and secures it aligning the harness orifices with the fluidic device inlet 590 as well as the housing outlet 560, but a harness orifice and/or a harness channel inlet require no additional fittings, attachments, o-rings, gaskets, tubing, and/or elastomeric seals for the sealing.

### Methods

The cartridge assemblies described may be used in a separation method, for example an electrophoretic separation. In some aspects, the electrophoretic separation may include isoelectric focusing. In some aspects, a sample containing at least one analyte is introduced into the separation channel. The sample may include, for example, glycans, carbohydrates, DNA, RNA, intact proteins, digested proteins, peptides, antibodies, metabolites, vaccines, viruses and small molecules. In some aspects, the sample may include a mixture of proteins, such as a lysate of cultured cells, cell-based therapeutics, or tumor or other tissue derived cells, recombinant proteins, including biologic pharmaceuticals, blood derived cells, perfusion or a protein mixture from any other source.

In an aspect, an electric field may be applied (e.g., across the separation channel). In some aspects, an electric field is applied across the separation channel to separate the sample generating at least one analyte peak. In some aspects, an electrical field may also cause the migration of the sample and/or analyte peak towards a fluid outlet. In an embodiment, the electrophoretic separation includes isoelectric focusing. For this method, pH gradient may be formed, e.g., via use of ampholytes (amphoteric electrolytes). For example, a sample may include at least one analyte and ampholyte(s) and may be subjected to isoelectric focusing in a separation channel by applying an electric field across the separation channel. In some aspects, the method may further include mobilization (accelerating separated ions towards the mass spectrometer and into an electrospray). In some aspects, after the electric field is applied across the separation channel (e.g. to focus the sample via isoelectric focusing), a mobilizer may be introduced in the separation channel. In some aspects, another electric field may be applied to mobilize the focused sample (and/or analyte peaks) towards a fluid outlet.

To enable monitoring and/or characterization of the separated analytes, ultraviolet (UV) absorbance detection, fluorescence detection, and/or mass spectrometry may be utilized. Mass of an analyte expelled from the fluidic device may be measured, for example, through time-of-flight mass spectrometry, quadrupole mass spectrometry, ion trap or orbitrap mass spectrometry, distance-of-flight mass spectrometry, Fourier transform ion cyclotron resonance, resonance mass measurement, or nanomechanical mass spectrometry.

In an isoelectric focusing method, the mobilization may be followed by ionization for the mass spectrometry analysis. In some embodiments, the ionization includes electrospray ionization. In some embodiments, ionization may be performed using a microfluidic device that is also used for isoelectric focusing and mobilization. Examples of such devices are provided in published PCT Patent Application Publication Nos. WO 2017/095813, WO 2021/108423, and WO 2021/222171, and U.S. Patent Application Publication No. US 2017/0176386, which are hereby incorporated by reference for all purposes.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A cartridge assembly comprising:
a fluidic device comprising a separation channel, at least one fluid inlet and at least one fluid outlet, and
a harness comprising at least a first polymer component and a second polymer component;
wherein the first polymer component comprises a low melting point polymer and at least one harness orifice, and
the second polymer component comprises a laminate of high melting point polymer, at least one harness channel, at least one harness channel inlet, and at least one harness channel outlet;
wherein the at least one harness channel outlet is configured to align with the least one harness orifice; and
the least one harness orifice is configured to align with the at least one fluid inlet.

2. The cartridge assembly of claim 1, wherein the laminate of high melting point polymer comprises at least a first high melting point polymer layer, a second high melting point polymer layer, and a third high melting point polymer layer.

3. The cartridge assembly of claim 2, wherein the second high melting point polymer layer comprises the harness channel and/or wherein at least a portion of the harness channel is cut into the second high melting point polymer layer.

4. (canceled)

5. The cartridge assembly of claim 2, wherein the first high melting point polymer layer and the third high melting point polymer layer comprise the at least one harness channel inlet and/or at least one harness channel outlet.

6. The cartridge assembly of claim 5, wherein the first high melting point polymer layer comprises the at least one harness channel outlet and the third high melting point polymer layer comprises the at least one harness channel inlet, and wherein the second high melting point polymer layer is positioned in between the first high melting point polymer layer and the third high melting point polymer layer.

7. The cartridge assembly of claim 6, wherein the harness channel comprises a first portion and a second portion, wherein the first portion is configured to align with the harness channel inlet and the second portion is configured to align with the harness channel outlet.

8. The cartridge assembly of claim 1, wherein the first polymer component is bonded to the second polymer component.

9. The cartridge assembly of claim 1, wherein the harness is sealed at an interface between the harness orifice and the fluid inlet using pressure and/or heat.

10. (canceled)

11. The cartridge assembly of claim 1, wherein the separation channel is configured to perform electrophoretic separation.

12. (canceled)

13. The cartridge assembly of claim 1, wherein the at least one fluid outlet is in fluid communication with an electrospray ionization orifice.

14. The cartridge assembly of claim 1, wherein the fluidic device further comprises at least one electrolyte channel each comprising at least one electrolyte channel inlet, wherein one of the at least one fluid inlet is the at least one electrolyte channel inlet, and wherein the at least one electrolyte channel is a catholyte channel, an anolyte channel, or a mobilizer channel.

15. (canceled)

16. The cartridge assembly of claim 14, wherein the separation channel comprises a separation channel inlet, wherein the at least one fluid inlet is the separation channel inlet, and wherein:
the harness comprises at least two harness orifices, wherein each harness orifice is independently configured to align with the at least one separation channel inlet and the at least one electrolyte channel inlet; or
wherein the harness comprises at least four harness orifices, wherein each harness orifice is independently configured to align with the at least one separation channel inlet, the anolyte channel inlet, the catholyte channel inlet, and the mobilizer channel inlet.

17. (canceled)

18. The cartridge assembly of claim 16, wherein the fluidic device further comprises at least one gas channel each comprising at least one gas channel inlet, wherein one of the at least one fluid inlet is the at least one gas channel inlet and wherein the harness comprises at least five harness orifices, wherein each harness orifice is independently configured to align with the at least one separation channel inlet, the anolyte channel inlet, the catholyte channel inlet, the mobilizer channel inlet, and the at least one gas channel inlet.

19. (canceled)

20. The cartridge assembly of claim 18, wherein the at least one separation channel inlet, the at least one electrolyte channel inlet, and the at least one gas channel inlet are disposed along a first edge of the fluid device.

21. The cartridge assembly of claim 1, further comprising a housing configured to encompass at least a portion of the fluid device, wherein the housing comprises at least one housing outlet and at least one housing channel, and wherein the at least one harness channel inlet is configured to align with the at least one housing outlet.

22. (canceled)

23. The cartridge assembly of claim 1, wherein the harness orifice does not require additional fittings, attachments, o-rings, gaskets, tubing and/or elastomeric seals to seal the harness orifice to the fluid inlet and/or the harness channel outlet.

24. The cartridge assembly of claim 22, wherein the harness channel inlet does not require additional fittings, attachments, o-rings, gaskets, tubing and/or elastomeric seals to seal the harness channel inlet to the housing outlet.

25. The cartridge assembly of claim 1 further comprising an electrode electrically connected to the harness channel and/or the housing channel.

26. The cartridge assembly of claim 25, wherein:
the electrode is disposed at an electrode reservoir or
the electrode is disposed at the electrode reservoir, and wherein a permeable ion membrane is disposed between the electrode reservoir and the harness channel or the housing channel.

27. (canceled)

28. A method for an electrophoretic separation, comprising:
introducing a sample comprising at least one analyte into the separation channel of the cartridge assembly of claim 1,
applying an electric field across the separation channel to separate the sample generating at least one analyte peak,
and detecting the at least one analyte peak with a detector.
